(19) United States
(12) Patent Application Publication
(10) Pub. No.: US 2011/0145591 A1
(43) Pub. Date: Jun. 16, 2011

(54) ADAPTIVE VIRTUAL ENVIRONMENT MANAGEMENT SYSTEM

(76) Inventor: Carl E. Grzybowski, Dallas, OR (US)

(21) Appl. No.: 12/639,125

(22) Filed: Dec. 16, 2009

(51) Int. Cl. G06F 9/455; G06F 12/08; G06F 12/14

(52) U.S. Cl. 713/189; 718/1; 711/118; 711/E12.017

(57) ABSTRACT

A user computing system configured to host a virtual user environment is disclosed. The system includes a local memory configured to store a plurality of data blocks and a programmable circuit operatively connected to the local memory. The programmable circuit is configured to execute program instructions to cause the user computing system to manage profile definition data including a manifest of software associated with a user, and host a virtual user environment on the device, the virtual user environment including executable instructions specific to the user computing system and constructed from data blocks stored in the local memory, the virtual user environment including a plurality of application programs and settings defined in the manifest.

### TECHNICAL FIELD

The present disclosure relates to creation and management of a user environment, e.g., using system virtualization techniques. More specifically, the present disclosure relates to a user and device specific environment management system.

### BACKGROUND

Individuals often use a number of different computing devices at different times of the day, and for different purposes. For example, an individual may use a laptop computing system at his/her workplace, which has installed on it a number of productivity tools and specific application programs that individual needs for his/her job function. That same individual may have a desktop computing system at home, and may use that system for gaming, user finances, or other personal uses. The individual may also own a cellular telephone, such as a smartphone, for one or both of business and personal use.

The above arrangement of computing systems results in a number of problems for an individual. For example, that individual may wish to catch up on his/her work when at home, or on the road. However, despite the proliferation of data connections, a number of applications are designed for operation on a desktop computing system, and cannot be run within a browser. The individual would then have to take along a work-issued laptop, carry files with him/her, or use remote access software to access data from his/her work network account. If they do not have a portable work computing device, they must make due with a substitute device, such as a personal computing device or smartphone. That substitute computing system likely lacks at least some of the computing capabilities and application software required by the individual, and also likely lacks equivalent security protections for data. Groups of similarly situated individuals may also have similar problems with respect to access of applications and data, and usability from remote or unfamiliar computing devices. Similar problems arise when an individual wishes to access personal information on a work computing system. Additional issues can arise in other contexts, where files, application software, and operating systems designated for a particular purpose are not available to a user of a different or unfamiliar computing device.

Existing solutions to these issues typically involve use of some type of virtual disk or virtual computer session allowing a personal computer to host a virtual version of a different personal computer, presenting a user interface representing that other system or environment. These virtual computer sessions provide certain advantages over web-based arrangements; notably, common security measures and self-contained, easier application management and security. However, virtual computer sessions typically require substantial computing resources, typically at least the same resources on the individual's current computing system as on the virtualized system. Therefore, mobile devices, thin clients, or other systems may be incapable of hosting a virtual environment due to the lack of computing resources on such systems. Furthermore, the settings for such virtual computer sessions are often provided as a generic session that does not reflect a user's specific system settings, file access history, or prior non-virtualized usage. Therefore, such virtualized sessions are neither made specific to the device that the individual is using, nor specific to the individual's personal requirements or settings.

Profile virtualization technologies are also emerging to address some of the above limitations by allowing user profiles to be injected into non-persistent virtual machines. However this extension on the virtual session arrangement above pairs a user profile to a single environment, and does not allow identity information to be coupled to a user's profile.

For these and other reasons, improvements are desirable.

### SUMMARY

In accordance with the following disclosure, the above and other problems are addressed by the following:

In a first aspect, a user computing system configured to host a virtual user environment is disclosed. The system includes a local memory configured to store a plurality of data blocks and a programmable circuit operatively connected to the local memory. The programmable circuit is configured to execute program instructions to cause the user computing system to manage profile definition data including a manifest of software associated with a user, and host a virtual user environment on the device, the virtual user environment including executable instructions specific to the user computing system and constructed from data blocks stored in the local memory, the virtual user environment including a plurality of application programs and settings defined in the manifest.

In a second aspect, a virtual user environment management system is disclosed. The virtual user environment management system includes a first user computing device having a first set of computing capabilities, and a second user computing device having a second set of computing capabilities, the second user computing device disparate from the first user computing device and the second set of computing capabilities incompatible with the first set of computing capabilities. The virtual user environment management system also includes a virtual user environment at least partially defined by a user manifest associated with a user, the virtual user environment providing a common user experience at either the first computing device or the second computing device, the virtual user environment formable from differing pluralities of data blocks, the virtual user environment constructed from a first plurality of data blocks for operation on the first user computing device and constructed from a second plurality of data blocks for operation on the second user computing device.

In a third aspect, a user computing system configured to host a virtual user environment is disclosed. The user computing system includes a local memory configured to store a plurality of data blocks and a programmable circuit operatively connected to the local memory. The programmable circuit is configured to execute program instructions which, when executed, cause the user computing system to manage profile definition data including a manifest of software associated with a user, and provide the manifest to an environment server. The programmable circuit is further configured to receive a response from the environment server including one or more data blocks useable to construct the virtual user environment on the device, the virtual user environment including executable instructions specific to the user computing system and constructed from data blocks stored in the local memory and including a plurality of application programs and settings defined in the manifest. The programmable circuit is further configured to host the virtual user environment on the device, detect a change to the virtual user environment, and edit the manifest to reflect the change.

### BRIEF DESCRIPTION OF THE DRAWINGS

FIG. 1 is a logical diagram of a computing network in which aspects of the present disclosure can be implemented;

FIG. 2 is a logical diagram of an example computing network implementing user and device specific virtualization, according to a possible embodiment of the present disclosure;

FIG. 3 is an example cover flow diagram of user virtual places available using the user profile and device specific virtualization systems and methods of the present disclosure;

FIG. 4 illustrates an example user key capable of defining requested functionality for a user device;

FIG. 5 illustrates a variety of logical block diagrams of user devices upon which user and device specific virtualization can be provided;

FIG. 6 illustrates a logical block diagram correlating block-based virtualized software to a user computing device, according to a possible embodiment of the present disclosure;

FIG. 7 illustrates a logical arrangement for block-based environment management and delivery, according to a possible embodiment of the present disclosure;

FIG. 8 is a block diagram illustrating example physical components of an electronic computing device useable to implement the various methods and systems described herein;

FIG. 9 is a flowchart of methods and systems for establishing user and device specific virtualization at a user device, according to a possible embodiment of the present disclosure;

FIG. 10 is a flowchart of methods and systems for supplying a user and device specific virtualized environment, according to a possible embodiment of the present disclosure; and

FIG. 11 is a flowchart of updating user specific aspects of a virtualized environment, according to a possible embodiment of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for providing user and device specific environment management and delivery. The legacy desktop metaphor contains items such as a clock, calendar, clipboard, recycle bin, and other similar elements. The proposed environment management and delivery systems implement virtualized systems that are familiar to the user in terms of representing a particular “place”, or user experience, with which the user is familiar. For example, a user may be familiar with the look, feel, and functionality provided by channels such as my: Workplace, House, Car, School, Investment Center, Health Center, or Gameland The focused environment can be presented to the user as a virtual place in a manner familiar and customized by the user, upon selection by the user, at an unfamiliar computing device. Although functionality may differ among disparate computing devices and systems based upon a particular device's capabilities, the methods and systems disclosed herein provide a consistent user experience across a number of different types of computing devices and systems. By “disparate” computing devices, it is intended that such devices are separate from and contain different functionality such that modifications to software would be required to execute that software on each device.

In certain aspects, the systems and methods described herein can create a mapping from a user to multiple environments (or virtual “places”), and can integrate the identity and rights of a user into a portable manifest. The systems and methods therefore present decoupled management of common component blocks used to create virtual user environments. Instead of traditional computer centric approaches that integrate profile management, this solution is “human-centric”, in that the virtual machine is associated with a user and portable across devices.

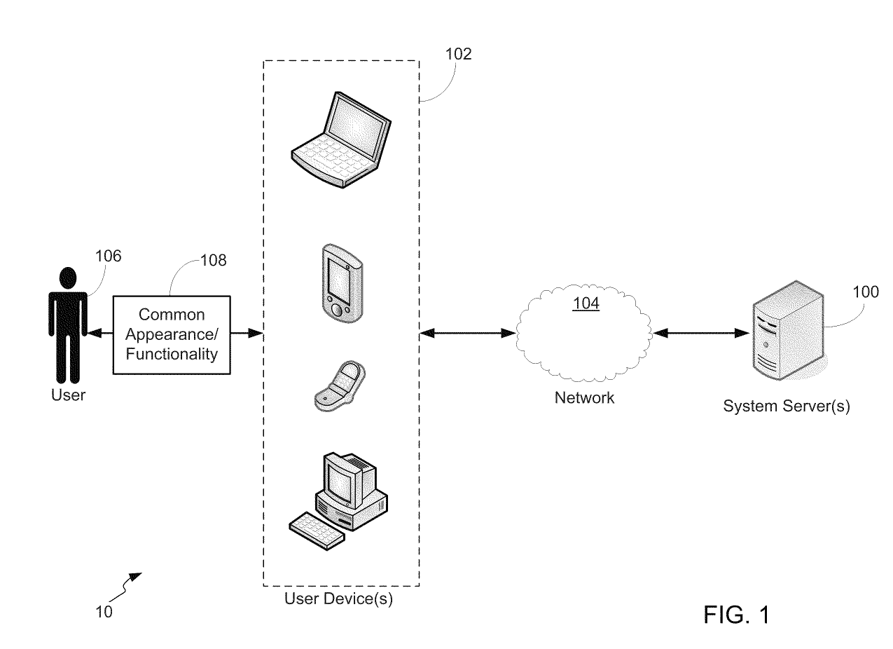

Referring now to the figures, FIG. 1 is a logical diagram of a computing network 10 in which aspects of the present disclosure can be implemented. The computing network 10 illustrates an example network in which a user can operate any of a number of computing devices and be presented with a common user interface across all devices, with the user interface providing a standard set of functionality (e.g., operating systems, application software, and data accessibility) across those devices, with adjustments made for the computing capabilities of the particular device currently operated by that user. Updates to the virtual manifest are saved to a cloud provider, such as an environment server provided in a manner that is opaque to a user. In such an arrangement, the computing network 10 can implement a “cloud” computing model that allows user access to virtual place and based on level of authentication used what data and applications are available from the cloud service.

In the embodiment shown, the computing network 10 includes an environment server 100 connected to a computing system 102 via a network connection 104. The environment server 100 generally represents one or more server computing systems capable of storing and delivering user environments to a number of different types of computing devices, based on user and device specific attributes it receives. The environment server 100 therefore can represent, in certain embodiments, computing resources behind a “cloud” computing arrangement capable of presenting a user environment at a computing device.

The computing system 102 generally represents any computing system at which a user 106 can access the network 104; in various embodiments, as illustrated, the computing system could be a desktop computing system, a laptop, smartphone, cellular telephone, tablet, netbook, or other mobile device. Such possible devices are illustrated within the logical block 102 representing a possible computing system. As would be recognized by the variety of possible computing systems represented by system 102, it is noted that numerous different sets of computing capabilities are available. For example, a desktop computing system will have typically greater processing power and available storage as compared to a netbook, smartphone, or other device. Furthermore, the devices may use different instruction sets, architectures, or driver software. However, it is understood that some level of virtualization capability (e.g. hypervisor software) would typically be provided on such devices.

The network connection 104 is a standard data connection, e.g., via an internet service provider or other data network host, capable of communicating large amounts of data between the computing system 102 and the environment server 100. For example, the network connection 104 can be any type of LAN, WAN, SAN, Internet, cellular network (e.g., 3G+), or other type of network useable for data communication. In certain embodiments, such as those in which sensitive data is transmitted, the network connection 104 is capable of providing a secure network connection between the computing system 102 and the environment server 100, such as by being within the same local network, by operating within a virtual private network, or by implementing security and/or encryption techniques for secure data communication. For example, in certain embodiments, the network connection 104 is capable of hosting data communication implemented between the computing system 102 and the environment server 100 using STEALTH technologies developed by Unisys Corporation of Blue Bell, Pa.

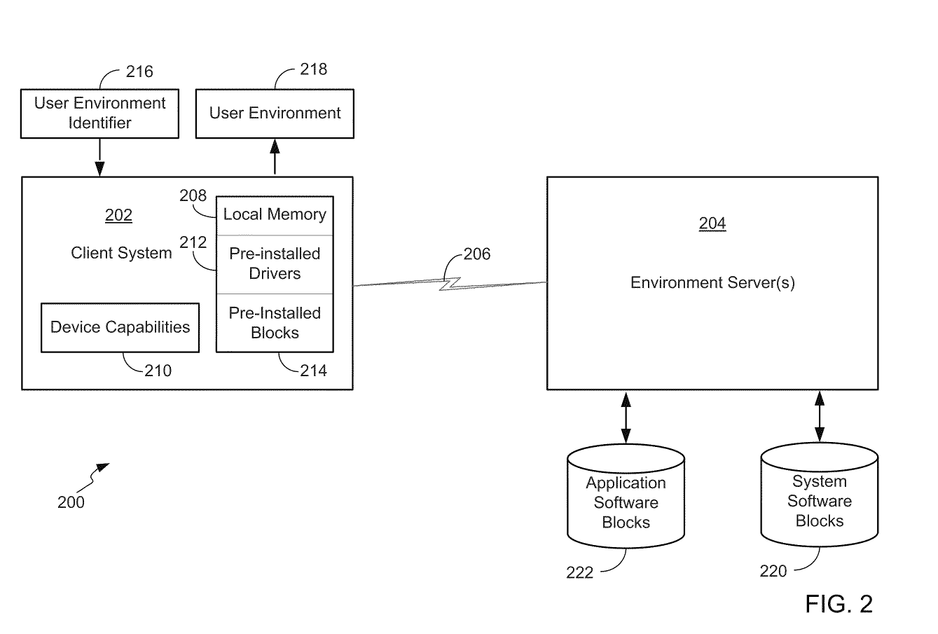

Through use of the communicative connection to an environment server 100, the computing system 102 presents to a user 106 a common user environment 108. The common user environment is an environment associated with the user and tailored to the particular computing system 102 operated by the user 106. The common user environment 108 presents to the user a set of operating and application software defined by user preferences and capabilities of the computing system, as presented in the environment definition provided in a user's manifest (as described below). Example methods for delivery of the user environment are disclosed in FIGS. 2-10, below. In certain embodiments, the common user environment 108 is a virtual user environment capable of emulating operation of a particular operating system and selected application software, and can present or make accessible certain appearance preferences and data to a particular user.

In a possible embodiment, the common user environment 108 is provided in a manner that is specific to the capabilities of the particular computing device 102 upon which it is intended to be executed. The common user environment 108 can include, for example, drivers configured to render local computing devices compatible with operating system and application software also included in the user environment. The common user environment is thereby made compatible with the local device receiving and presenting the common user environment to a user 106.

Alternatively, based on a particular set of device capabilities, the common user environment 108 can be formed to include each of the application programs associated with a particular user profile or environment, but based on capabilities of the computing device 102, the environment may be formed using versions of those application programs that use greater or lesser computing resources. For example, a user may require word processing software to be present within a common user environment 108 associated with that user's selected profile. While on a desktop computing system a full version of the word processing software could be provided as a part of the common user environment; while on a smartphone or other similar device, that same word processing software (as opposed to a limited, separately created mobile version) could be provided as a part of the common user environment, but could have certain functionality limited, where that functionality requires substantial computing or memory resources. In such cases, the user is provided with analogous appearance and the same software, but the overall feature set provided by the software may be adjusted based on the particular device's computing capabilities.

In certain embodiments, the common user environment 108 is formed from a combination of software stored on the computing system 102 and on the environment server 100. For example, the common user environment 108 can be formed from blocks of data cached at the computing system 102 from a previous instantiation, as well as additional blocks of data from the environment server 100. A de-duping process can be implemented to ensure that the server retrieves and sends to the computing system 102 only the software blocks required to form the common user environment that are not already at the computing system to reduce the amount of data required to be transmitted between the two systems.

The common user environment 108 can be formed based on a request received from the computing system 102, which can include a set of user preferences and software, as well as a claims-based security determination arrangement. Additionally, the software can be transmitted from the environment server 100 to the computing system 102 as block-based data, including an entire block-based virtual image or a block-wise update or change to a virtual image (e.g., using the de-duping process). Additional details are provided regarding example implementations of these features in FIGS. 2-10, below.

FIG. 2 is a logical diagram of an example computing network 200 implementing user and device specific virtualization, according to a possible embodiment of the present disclosure. The computing network 200 can be, for example, a particular implementation of the network 10 of FIG. 1. The computing network 200 includes a computing device 202 and an environment server 204, communicatively connected by a communication link 206. The computing device 202 can be any of a number of different types of devices capable of communicative connection to an environment server, as described above with respect to the computing device 102 of FIG. 1. The environment server 204 is analogous to server 100 of FIG. 1, but illustrates a particular implementation of the network of FIG. 1 for forming and providing a user environment, in which the environment provided is a virtual user environment. As with the network connection 104, the communication link can be any of a number of types of communicative connections, and can employ a variety of different possible data security measures to protect sensitive data within a particular environment. In certain embodiments, the communication link 206 uses STEALTH™ block-based encryption and splitting technologies developed by Unisys Corporation of Blue Bell, Pa., for the purposes of maintaining data security.

The computing device 202 includes a local memory 208. The local memory 208 can store information about device capabilities 210 and optionally also software required for operation of the computing device 202, e.g., device drivers 212. The local memory 208 can also be configured to store one or more pre-installed blocks 214 of data representing a portion of an operating system or application programs. For example, the pre-installed blocks 214 can include portions of previously loaded virtual user environments, and can include host software useable to execute the virtual user environments. Other software can be included in the pre-installed blocks as well.

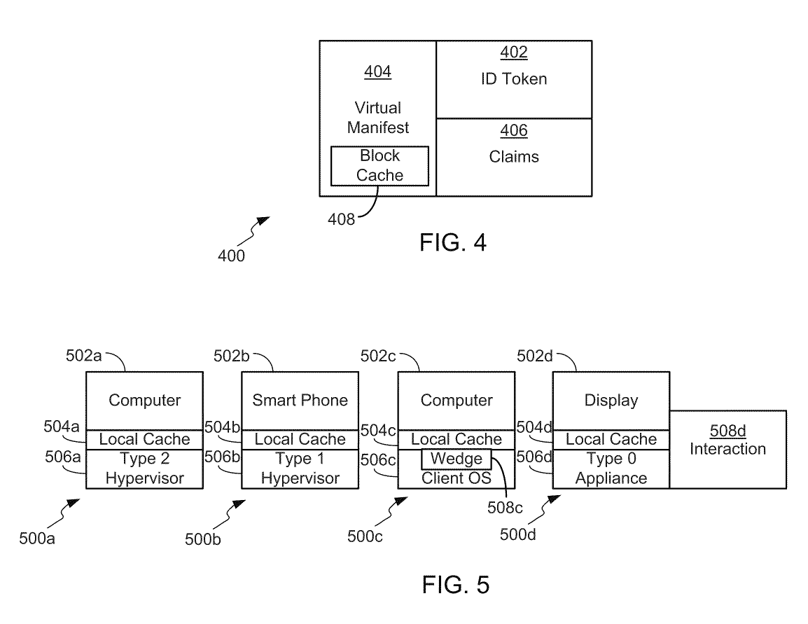

The computing device 202 is configured to receive an identifier 216 from a user that can identify a desired environment to be formed and provided that is related to that user. The identifier can take any of a number of forms. In certain embodiments, the identifier is a token or other identifying file carried by a user (e.g. on a portable memory device, access card, or other handheld or smaller sized identification device) and delivered to the computing device 202. In other embodiments, the identifier 216 is generated at the computing device 202 based on an authentication process initiated by a user, and can be formed from local storage or from a remote system holding user profile information. In one particular embodiment, as illustrated in FIG. 4, the identifier 216 can correspond to a user key, including a manifest of profile information and Other embodiments are possible as well.

In use, the computing device 202 and environment server 204 cooperate to present to a user a common user environment 218. The common user environment 218 is created by the computing device 202 and environment server 204 using the methods and systems described herein. The common user environment 218 presents a virtual user environment for operation by a user, which can include a virtualized operating system, application software, and data connections, as described above.

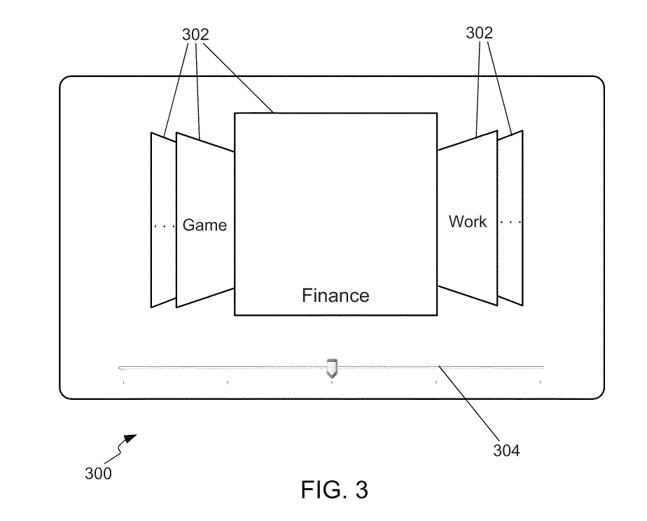

Optionally, a user can be presented with a user interface to select a profile from among a plurality of profiles defined for that user. Each profile represents a set of settings related to the user that define the user-specific portion of a common user environment (i.e., the portion lacking device specific capabilities). The profile can have a name recognizable to the user, e.g., “work”, “home”, “gaming” or other name. An example user interface capable of presenting available user profiles is illustrated in FIG. 3.

In certain embodiments, the user can correspond to a group or class of users assigned a common user environment, for purposes of collaboration or ease of distribution of common settings, applications, data, or other features.

To create the common user environment, typically a user will provide to the computing device 202 the identifier 216. The identifier 216 validates the user as a particular individual, by using one of a number of possible authentication techniques (e.g., username/password, token-based authentication, biometric authentication, or other methods). The identifier is combined with additional information about the user and the computing device 202, and that combined information is sent to the environment server. The combined information can include, for example, a manifest of programs and settings defining a virtual user environment, a token that identifies the user, and one or more rights-based claims made of the environment server related to usage rights of software, access rights to data or other computing systems, or other types of access rights. In certain embodiments, the manifest includes settings specific to the user and includes a definition of capabilities of the computing device 202. In certain embodiments, the claims are made as a part of the authentication process for the user, and are made in the context of a claims-based authentication process, as can be provided using Active Directory Federated Services and CardSpace software supplied by Microsoft Corporation.

In response to receipt of the above-identified information from the computing device 202, the environment server 204 forms a virtual user environment that can be operated on the computing device 202. The virtual user environment is, in certain embodiments, formed as a block-based image from one or more databases of software blocks that can be combined into an image of the desired environment and delivered to the computing device. In the embodiment shown, the software blocks can be drawn from a database of system software blocks 220 and/or a database of application software blocks 222.

Through use of component blocks for decomposition and recomposition of the virtual user environments provided by environment server 204, incremental updates can be provided and certain blocks can be reused across different user environments (either for the same user or for different users having virtual user environments with common aspects, e.g., operating system or application software). Additionally, due to the increased speed provided by block-based write operations (as opposed to file-based write operations), environment updates can be performed efficiently.

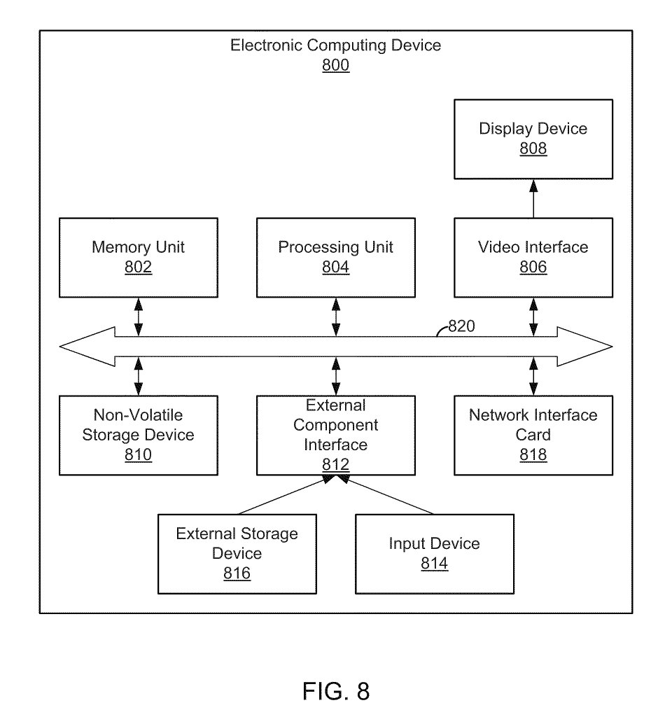

In certain embodiments, only a portion of the image is delivered to the computing device 202, for example in cases where the computing device already has stored at least a portion of the software forming the image (e.g., in blocks 214 or other preinstalled software, such as drivers 212). In other embodiments, the entire image is delivered to the computing device 202. The image is loaded at the computing device 202 and can be used to present the user with a common user environment as previously described. Additional details regarding supplying a virtual user environment are described below in conjunction with FIGS. 8-10.

The environment server 204 forms the user environment from database 200, and also manages various user environments. The environment server 204 therefore can manage changes to user environments occurring even while no device has that environment loaded. For example, the environment server 204 (or some other cloud-based computing system) could receive registration from the user to receive updates to the user environment or to process data. For example, a user can subscribe to data collections (investment reports, news, etc.) or prepare reports such that the environment server or other cloud service continually updates the virtual environment. Upon a next use by the user, that information could be updated and included in the user environment. Additionally, the user environment could be linked to an external data device (e.g., a home video camera or doorbell) such that the user environment is sent an alert when that item receives particular data (e.g., the video camera detects motion or the doorbell is rung).

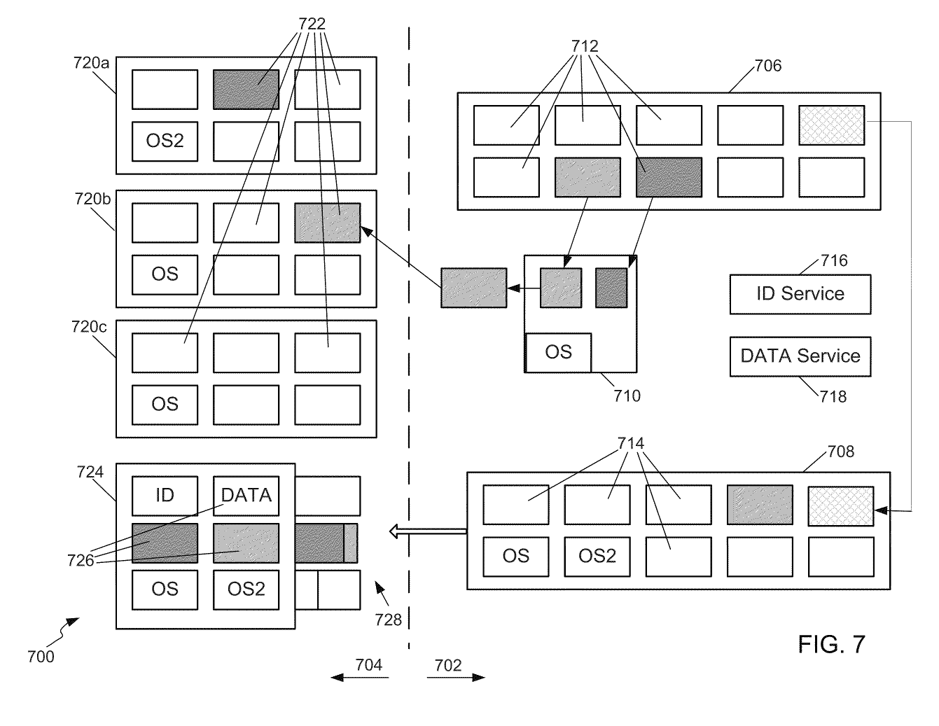

In certain embodiments, the environment server 204 can correspond to a number of different servers in a manner opaque to a user device. For example, the environment server 204 could include cloud-based services, and can separate the various types of information provided (e.g., personal data, application data blocks, service provider data blocks, or other types as specified in FIG. 7, below) into various subsystems or cooperating systems.

FIG. 3 is an example user interface 300 showing a “cover flow” style arrangement of selectable user profiles implemented using the user and device specific virtualization systems and methods of the present disclosure. The user interface 300 can be presented to a user of a computing device to select a particular profile for delivery from an environment server such as illustrated in FIG. 2, above. As illustrated, the user interface 300 includes a plurality of graphical regions 302 each displaying the corresponding, selectable user profiles, as well as a slider bar 304 that assists the user in navigating among the available user profiles.

In certain embodiments, the profiles displayed are loaded and displayed in the user interface 300 based on their description within a manifest or other user file containing a description of each of the profiles associated with a user. In other embodiments the profiles are displayed based on information stored at the computing device or remotely as related to the identified user.

The user interface 300 receives user selection of a profile, for example by determining that the user selects a profile by using an input device to select one of the graphical regions 302. User selection of a profile can determine a particular set of user-specific settings (e.g., a particular set of settings from a user-specific manifest) to be sent to a remote server (e.g., environment server 204) for loading user-specific parameters for a user-specific and device-specific profile.

FIG. 4 illustrates an example user key 400 capable of defining requested functionality for a user device, The user key 400 can, in certain embodiments, represent information transmitted from a computing system to an environment server to allow that environment server to form a corresponding common user environment for that user, adjusted to be compatible to the requesting computing device.

In the embodiment shown, the user key 400 includes a token 402, a manifest 404, and one or more claims 406. The token 402 can be, for example, a token generated at a local computing system based on authentication of a user, e.g., by use of a username/password, biometric identification, or by receipt as a security token directly from a portable user device, such as a flash memory drive having a USB interface. The manifest 404 includes a listing of user settings defining the information needed to create a common user interface for that user, according to a profile selected by the user. The manifest 404 can be, in certain embodiments, a metadata file (e.g., XML or other markup language) describing features to be associated with the user, including programs to be included within a user environment, user appearance and preference settings (e.g., language and/or font settings), operating system settings, and other settings that may vary among users.

The claims 406 define the user's interaction with a remote system, for example, by defining resource usage rights on behalf of a user in a request-based system. The claims 406 can, in certain embodiments, each include a type, right and resource in a structured manner. Typically, the claims 406 are used by transmitting a lowest-level claim to a server to allow that user/device to use a requested service. The claims can therefore be managed to transmit one or more claims as required from the user key 400 to a remote system to request access to the desired system. The claims 406 can be compared to access control lists to allow remote systems (e.g., systems external to a LAN or other controlled network) to access resources that are traditionally managed within a controlled or closed network. For example, the claims 406 can be formed and managed based on a claim structure provided within an Active Directory Federation Services and Cardspace software provided by Microsoft Corporation of Redmond, Wash.

In certain embodiments, the manifest 404 can include a block cache 408, which indicates the particular software blocks residing at the user's computing device (e.g. device 100 of FIG. 1). The block cache 408 provides encrypted storage of data and application blocks that are locally available to build user environments. The block cache 408 additionally allows for offline use of the user environment, and can be synchronized upon connection with an environment server as illustrated above, or generally with a cloud computing service.

In certain embodiments, each of the items in the user key 400 can be included with the token 402 in a personal storage device, such as a USB storage device. In other embodiments, only the token 402 is stored on a personal storage device, and other user-specific or device-specific information can be derived from that information (e.g., by accessing a remote server) or can be cached on a local computing system, such as system 102 of FIG. 1, above.

In certain embodiments, the user key 400 provides rights to and defines user access to a group of users. Such an arrangement may be advisable in situations where a group of individual users shares data and is to be granted a common set of permissions within a common environment. For example, a group of colleagues in a work environment may wish to share a particular arrangement for product development or some other situation in which common access rights would be required. In such situations, the user key 400 allows access to the environment, while outsiders (those lacking access to the user key 400 could be precluded from data access by implementing data and connection security measures on the user environment and related user key 400 (e.g., using password or biometric authentication to access the key).

FIG. 5 shows a variety of logical block diagrams 500a-d that represent example user devices upon which user and device specific virtualization can be provided, for example, based on the user key 400 of FIG. 4. The user devices 500a-d can, for example, correspond to the computing system 102 of FIG. 1.

User device 500a illustrates a computing system useable to provide a (preferably) essentially seamless experience to a user, as compared to operation of a traditional system that uses local physical storage for management of a user experience. User device 500a includes a computer 502a that includes a local cache 504a capable of hosting a virtual environment 506a. The computer 502a can be any of a number of systems capable of hosting a virtual instance of a user environment that would typically be presented to that user, for example, as a home or work user environment including a number of productivity or other types of applications, and includes sufficient computing resources to host a full-capability virtual installation of a user environment. The virtual environment 506a is illustrated as being implemented with a Type-2 hypervisor, which refers to a hypervisor or virtual system host software that can operate within a conventional operating system (e.g., a virtual software host within a Windows, Apple, Linux, or other operating system). Example virtual system host software can include, for example, VMWare Server software of VMWare, Inc. of Palo Alto, Calif., or Virtual PC software from Microsoft Corporation of Redmond, Wash. Other types of hypervisor software could be used as well.

User devices 500b and 500c illustrates alternative computing systems that are useable to host a user-customized and device-customized user environment. The user device 500b, 500c represent different types of devices (in the embodiment shown, listed as a smart phone device 502b and a computer 502c, respectively) that have different computing capabilities (e.g., different processing speeds, memory capacities, instruction set architectures, or other device-specific attributes).

Device 500b could include a virtual environment 506b that hosts a virtual user environment for the user as delivered based on the user key 400 of FIG. 4. In the embodiment shown, the virtual environment 506b is illustrated as a Type-1 hypervisor, which refers to a hypervisor or virtual system host that operates natively on hardware of a particular device. Type 1 hypervisors are available for server environments such as VMWare ESX Server, or Microsoft's Hyper-V virtual systems. Desktop Type 1 Hypervisors are just emerging such as Virtual Computer NxTop, Neocleus, and Intel's XenDesktop/vPro.

Computer 502c illustrates another approach that would apply emerging technology that embeds the virtual container inside of an operating system running on that system. Device 500c therefore is depicted as including a client operating system 506c that includes a wedge 508c. The wedge 508c hosts an isolated virtual user environment that can be run from within the host operating system 506c. As such additional operating system licensing for the virtual container is not required. For example, such functionality can be provided by vDesk software from RingCube Technologies, Inc. of Mountain View, Calif.

Furthermore, when comparing user devices 500b and 500c, it is noted that typically, different user devices will have different capabilities. For example, if one such user device is a smart phone device (e.g., device 500b) and a second user device is a computer (e.g., device 500c), those devices will typically operate on different instruction set architectures, have different amounts of cache, RAM, processing capabilities, hard disk space, connectivity speeds, and other features. Therefore, although each of these systems can operate using the same type (or a different type) of virtual environment, each system will send to a server its particular capabilities, thereby allowing the server to formulate and send to that system a particular virtual environment that is tailored both to the user (e.g., as defined using the user key of FIG. 4) and to the device (e.g., based on the device's capabilities as transmitted with the user key to the server).

User device 500d illustrates a further alternative system that entirely implements a virtual environment without use of a software host package. The device 500d can be, for example, a type-0 appliance that receives a customized user environment, lacking a native operating system or execution capabilities (e.g., a set top box or other similar devices). Rather, the device 500d, in the embodiment shown, receives a virtual environment 506d into local cache 504d. Display 502d and interaction component 508d (e.g., keyboard, mouse, touchscreen, touchpad, or other user interaction device) can provide interaction with the virtual environment 506d to the user. User device 500d therefore does not require a native operating system or particular computing capabilities; rather, it includes a minimum set of capabilities, with processing, memory, and other computing capabilities handled by a separate system to which the device 500d is communicatively connected (e.g., a back-end server system to which device 500d is communicatively connected). In this situation, because of the availability of the back-end server system or other system that provides computing capabilities associated with user device 500d, the user device capabilities used to determine the particular capabilities provided in the virtual environment 506d can be based in part upon the capabilities of the device 500d, but also could be based in whole or in part upon the capabilities of the back-end system used to host the computing operations that are provided to the user from device 500d.

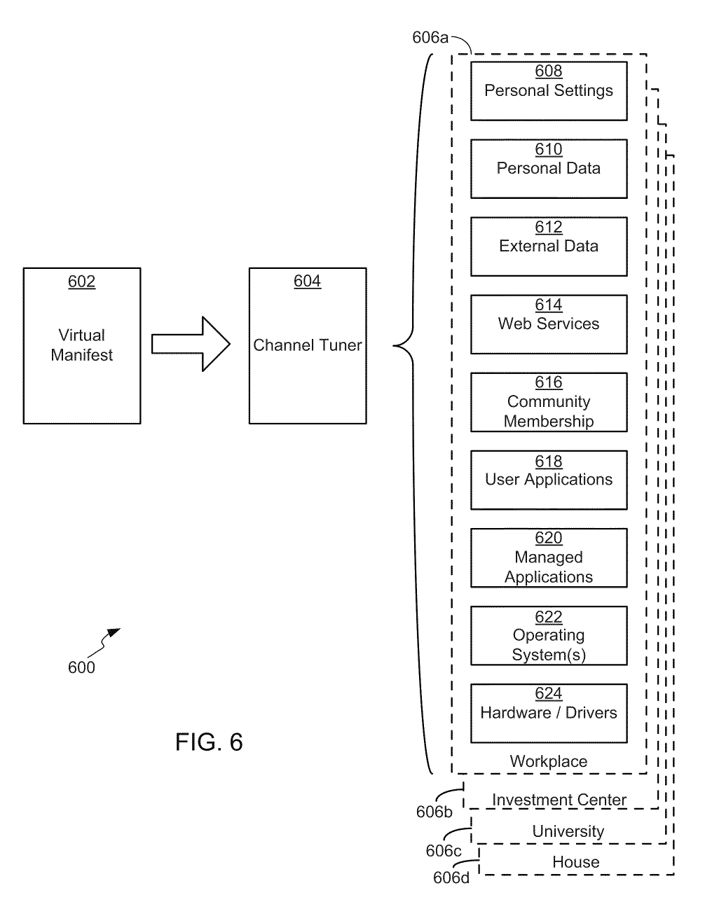

FIG. 6 illustrates a logical block diagram 600 correlating block-based virtualized software to a user computing device, according to a possible embodiment of the present disclosure. The logical block diagram 600 shows a virtual manifest 602, channel tuner 604, and one or more resulting user environments, shown as virtual user environments 606a-d. The virtual manifest 602 can include user-specific information relating to programs, operating systems, appearance settings, and other information that is received from the user to formulate the virtual user environment. In certain embodiments, the virtual manifest 602 includes one or more portions of the user key 400 of FIG. 4, including, for example, manifest 404.

The channel tuner 604 presents to a user different channels available for display to the user. The channel tuner 604 can include, for example, a user interface (e.g., user interface 300 of FIG. 3) for selection of one of a plurality of channels representing particular virtual user environments deliverable to the computing device operated by the user. As explained above, each of the selectable virtual user environments can include a different appearance, set of application programs, operating system, or other information.

The virtual user environments 606a-d represent various “places” or locations/environments associated with the user. In the embodiment shown, environment 606a represent a workplace user environment, 606b represents an investment center environment, 606c represents a university environment, and 606d represents a house user environment. Each environment may contain a different operating system, applications, preferences, and other features.

In the embodiment shown, virtual user environment 606a (and likewise 606b-d) is constructed in response to user selection of a particular virtual user environment using the channel tuner 604. The virtual user environment 606a is delivered to the user device for execution, e.g., on a device such as those illustrated in FIG. 5. Different software and logical blocks could be included into different virtual user environments, as selected by the user. In the embodiment shown, the virtual user environment 606 includes a number of software components, including user settings 608, personal data 610, external data 612, web services 614, community membership 616, user applications 618, managed applications 620, operating system(s) 622, and hardware/driver-specific software 624.

The user settings 608 include display settings, preferences, icons, display themes, shortcuts, and other information specific to the user. The personal data 610 can include files, bookmarks, links, and other information that is specific to the user and stored at a server that maintains the user's data and profile information (e.g., as illustrated in FIG. 1, above). Other information could be included as well. The external data 612 includes generally-available information to be collected and provided to a user from publicly-available sources. The web services 614 provide data connectivity to other systems external to the one operated by the user.

Additionally, the community membership information 616 includes information regarding particular user groups to which the user belongs, for example to provide access to certain categories of data to that user, or to allow the virtual user environment to belong to a particular group of users. The user applications 618 represent the list of application-level programs identified by the user to be included in the virtual user environment 606. The managed applications 620 can be any of a number of remotely managed applications for which a portion of the application can be included into the virtual user environment 606, and for which a portion of the application remains at a remote computing system for remote management.

The operating system(s) 622 can also be selected as specific to a particular virtual user environment, and can be any of a number of known operating systems. Because the environment 606a is disclosed as virtual, the selected operating system 622 need not be compatible with the instruction set architecture of the particular user device; rather, the operating system can be selected to provide a common usage experience to an individual, with execution of that operating system managed by the translating virtualization software (or remote system, in the case of a type-0 appliance).

The hardware/driver-specific software 624 provides hardware-specific software that is responsive to the hardware capabilities of the system receiving the virtual user environment. The hardware/driver-specific software 624 can include any of a number of registry, driver, and other operational software systems configured to render the virtual user image compatible with the specific hardware configuration of the computing device operated by the user. Device capabilities includes bandwidth for streaming the virtual image to the device, computing resources, memory, expected user computing power required, or other factors. Other software systems and modules can be incorporated into the virtual user environment 606 as well.

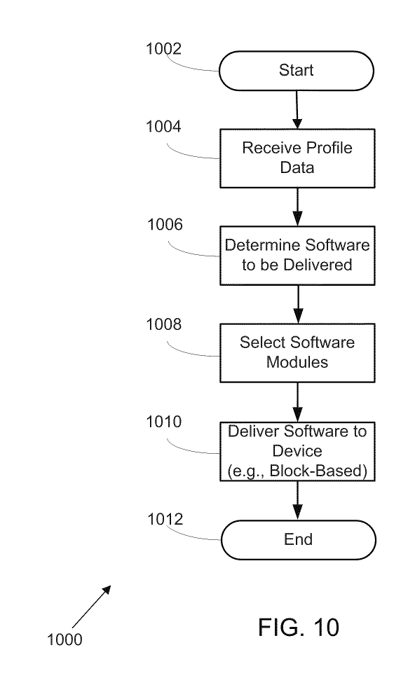

In certain embodiments, the software components 608-624 are stored at an environment server (e.g. server 204 of FIG. 2) in a granular, block-wise basis, such that a virtual user environment can be formed by concatenation or other combination of a number of software blocks based on the contents of a user profile (as dictated by user selection using channel tuner 604). In such cases, user interaction may require alteration of the user profile or of the virtual user environment itself (e.g., in the case of installation of new software, changes in user preferences or data, or other interactions). Methods of monitoring and altering a virtual user environment and profile are discussed in conjunction with FIG. 10, below.

In further embodiments, the software components 608-624 can be cached at the local user device (as mentioned above with respect to FIG. 4) to allow a user to receive user-specific blocks. De-duping processes can be employed to ensure that common software blocks (e.g., operating system blocks, or other non-user-specific blocks) are not required to be re-transmitted to a user device.

FIG. 7 illustrates further details of a block-based environment delivery system 700, according to a possible embodiment of the present disclosure. The system 700 illustrates block management and delivery from one or more servers (e.g., environment servers) and formation of user environments at client devices based on cached and received block-based data.

In the embodiment shown, the system 700 is logically separated into server space 702 and local space 704. The server space 702 generally refers to a location at which data blocks are remotely managed, or at which identity or data verification services are performed generally abstracted and obscured from observation by a client (e.g., as part of a cloud service or other server-based arrangement). The local space 704 generally corresponds to local memory of a device configured to receive data blocks and form a user environment therefrom; in various embodiments, the local space can be located local to or remote from a user, as explained in connection with the different types of user devices 500a-d of FIG. 5.

The server space 702 generally includes a plurality of functionality providers, which can correspond to one or more entities. These functionality providers can include, for example, an application data provider 706, a device infrastructure provider 708, and a virtualization service provider 710. Other providers or multiple of these types of providers could be included within the server space 702 as well.

The application data provider 706 represents an entity capable of storing, managing, and providing data blocks representing application data for one or more user applications to be included in virtual user environments. The application data provider 706 stores data blocks 712 representing portions of applications, and those data blocks 712 can be combined at a user device to provide application data to form an executable application containing functionality desired by the user of that device.

The device infrastructure provider 708 similarly represents an entity capable of storing, managing, and providing data blocks representing device infrastructure data to be included in virtual user environments. For example, the device infrastructure provider 708 can store data blocks 714 that can be combined to form operating systems or other software executed at a user device. In various embodiments, the application data provider 706 and device infrastructure provider 708 can be hosted at the same or different sites or by affiliated or unaffiliated computing systems.

The virtualization service provider 710 provides a conduit to deliver virtual user environments, and can optionally provide a linkage between the application data provider 706, device infrastructure provider 708, and a local space 704. In the embodiment shown, the virtualization server is interfaced to the application data provider 706 and can provide data blocks to an appropriate user device for use in a virtual user environment. The virtualization service provider 710 can also optionally host identification service 716 and data service 718, which correspond to server-side validation and parsing of information received from a user device that defines one or more virtual user environments (e.g., the manifest and associated information received from a user device as illustrated in FIG. 6, above). The identification service 716 can validate a user and assign security rights to that user based on claims received from the user device, while the data service 718 can generate a listing of data blocks that should be provided to the user device to form a virtual user environment as defined in the manifest.

In the example illustrated, the virtualization service provider 710 provides a conduit for the application data provider 706, while the device infrastructure provider 708 directly presents data to a local space 704. Other embodiments are possible as well.

In further embodiments, additional service providers can be included. For example, additional separate service providers can be included for delivering appliance maintenance services, data or manifest updating services, managing identity and/or claims information associated with a user, application delivery, virtual user environment delivery, or other provider types.

The local space 704 is shown as capable of receiving and loading into memory a plurality of virtual user environments 720a-c. Each of the virtual user environments 720a-c includes a plurality of blocks 722, including blocks containing application data, personal data, and operating system or other device-specific data. Although in the embodiment shown three virtual user environments are depicted, more or fewer environments could be included, based on the particular contents of the manifest and user requirements.

In certain embodiments, the virtual user environments 720a-c can be formed and hosted in a number of different ways. For example, a first virtual user environment could be hosted remotely, while a second could be hosted locally but execute remotely-hosted applications. A further virtual user environment could be entirely locally stored at a user device.

The local space 704 also includes a local storage 724 that includes device service blocks 726, which are used to host and execute the various virtual user environments on a user device. The local storage 724 supports differential updating, such that updates made either at the server or at the client can be propagated and synchronized. In the example shown, updates occurring within the device infrastructure provider are transmitted to the local storage 724, to provide updated executable software for operation at a user device, e.g., based on changes to a manifest or as dictated by a server-side or other computing system. The local storage 724 can include one or more update queues 728 that receive updates from one or more remote providers, and can replace or modify preexisting blocks within the local storage 724 as needed and as available (e.g., not currently in use).

FIG. 8 is a block diagram illustrating example physical components of an electronic computing device 800, which can be used to execute the various operations described above, and can be any of a number of the devices described in FIGS. 1-2 and 5, above. A computing device, such as electronic computing device 800, typically includes at least some form of computer-readable media. Computer readable media can be any available media that can be accessed by the electronic computing device 800. By way of example, and not limitation, computer-readable media might comprise computer storage media and communication media.

As illustrated in the example of FIG. 8, electronic computing device 800 comprises a memory unit 802. Memory unit 802 is a computer-readable data storage medium capable of storing data and/or instructions. Memory unit 802 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, electronic computing device 800 comprises a processing unit 804. As mentioned above, a processing unit is a set of one or more physical electronic integrated circuits that are capable of executing instructions. In a first example, processing unit 804 may execute software instructions that cause electronic computing device 800 to provide specific functionality. In this first example, processing unit 804 may be implemented as one or more processing cores and/or as one or more separate microprocessors. For instance, in this first example, processing unit 804 may be implemented as one or more Intel Core 2 microprocessors. Processing unit 804 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 804 may be implemented as an ASIC that provides specific functionality. In a third example, processing unit 804 may provide specific functionality by using an ASIC and by executing software instructions.

Electronic computing device 800 also comprises a video interface 806. Video interface 806 enables electronic computing device 800 to output video information to a display device 808. Display device 808 may be a variety of different types of display devices. For instance, display device 808 may be a cathode-ray tube display, an LCD display panel, a plasma screen display panel, a touch-sensitive display panel, a LED array, or another type of display device.

In addition, electronic computing device 800 includes a non-volatile storage device 810. Non-volatile storage device 810 is a computer-readable data storage medium that is capable of storing data and/or instructions. Non-volatile storage device 810 may be a variety of different types of non-volatile storage devices. For example, non-volatile storage device 810 may be one or more hard disk drives, magnetic tape drives, CD-ROM drives, DVD-ROM drives, Blu-Ray disc drives, or other types of non-volatile storage devices.

Electronic computing device 800 also includes an external component interface 812 that enables electronic computing device 800 to communicate with external components. As illustrated in the example of FIG. 8, external component interface 812 enables electronic computing device 800 to communicate with an input device 814 and an external storage device 816. In one implementation of electronic computing device 800, external component interface 812 is a Universal Serial Bus (USB) interface. In other implementations of electronic computing device 800, electronic computing device 800 may include another type of interface that enables electronic computing device 800 to communicate with input devices and/or output devices. For instance, electronic computing device 800 may include a PS/2 interface. Input device 814 may be a variety of different types of devices including, but not limited to, keyboards, mice, trackballs, stylus input devices, touch pads, touch-sensitive display screens, or other types of input devices. External storage device 816 may be a variety of different types of computer-readable data storage media including magnetic tape, flash memory modules, magnetic disk drives, optical disc drives, and other computer-readable data storage media.

In the context of the electronic computing device 800, computer storage media includes volatile and nonvolatile, removable and non-removable media implemented in any method or technology for storage of information such as computer readable instructions, data structures, program modules or other data. Computer storage media includes, but is not limited to, various memory technologies listed above regarding memory unit 802, non-volatile storage device 810, or external storage device 816, as well as other RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the electronic computing device 800.

In addition, electronic computing device 800 includes a network interface card 818 that enables electronic computing device 800 to send data to and receive data from an electronic communication network. Network interface card 818 may be a variety of different types of network interface. For example, network interface card 818 may be an Ethernet interface, a token-ring network interface, a fiber optic network interface, a wireless network interface (e.g., WiFi, WiMax, etc.), or another type of network interface.

Electronic computing device 800 also includes a communications medium 820. Communications medium 820 facilitates communication among the various components of electronic computing device 800. Communications medium 820 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

Communication media, such as communications medium 820, typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Electronic computing device 800 includes several computer-readable data storage media (i.e., memory unit 802, non-volatile storage device 810, and external storage device 816). Together, these computer-readable storage media may constitute a single data storage system. As discussed above, a data storage system is a set of one or more computer-readable data storage mediums. This data storage system may store instructions executable by processing unit 804. Activities described in the above description may result from the execution of the instructions stored on this data storage system. Thus, when this description says that a particular logical module performs a particular activity, such a statement may be interpreted to mean that instructions of the logical module, when executed by processing unit 804, cause electronic computing device 800 to perform the activity. In other words, when this description says that a particular logical module performs a particular activity, a reader may interpret such a statement to mean that the instructions configure electronic computing device 800 such that electronic computing device 800 performs the particular activity.

One of ordinary skill in the art will recognize that additional components, peripheral devices, communications interconnections and similar additional functionality may also be included within the electronic computing device 800 without departing from the spirit and scope of the present invention as recited within the attached claims.

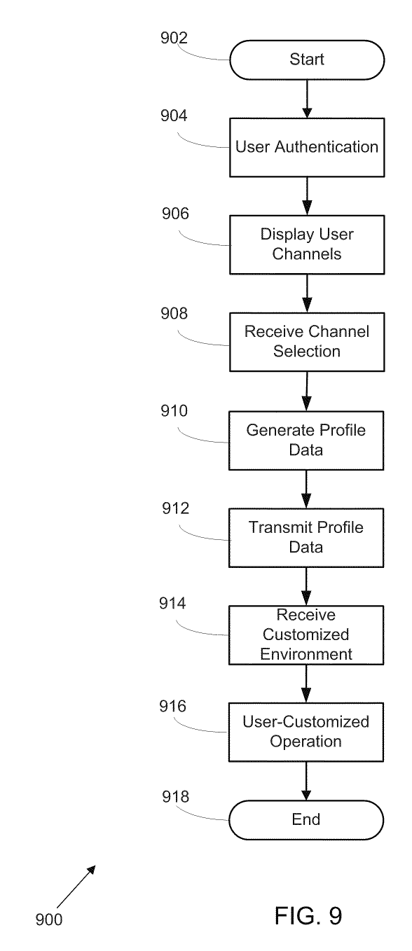

Now referring to FIGS. 9-11, various operational methods and systems are provided that illustrate example implementation and use of the hardware and software components described above. FIG. 9 is a flowchart of methods and systems 900 for establishing user and device specific virtualization at a user device, according to a possible embodiment of the present disclosure. The methods and systems 900 can be used at a device such as devices 500a-d of FIG. 5, to request, receive, and operate within a virtual user environment, according to the principles described herein. The methods and systems 900 are instantiated at a start operation 902, which can correspond to initial use of a user computing device.

A user authentication module 904 receives user authentication credentials from a user to verify the user's (or group of users') identity. The user authentication module 904 can obtain any of a number of forms of user authentication. For example, in a first embodiment, the user authentication module 904 receives an electronic token from a portable memory device, such as a USB memory device. In a second embodiment, the user authentication module 904 receives a username and password from the user. In a further embodiment, biometric data could be captured at a user device. In another embodiment, remote data or data cached at a local computing system could be at least partially used to authenticate a user. Additionally, any combination of the above authentication techniques can be used.

A channel display module 906 displays to the authenticated user one or more channels available for selection. Each of the channels displayed by the channel display module 906 The channel display module can, in certain embodiments, display a “cover flow” style user interface to a user for selection of a channel, such as user interface 300 of FIG. 3.

A channel reception module 908 receives selection of a channel from the user, as based on the channel display module 906. A profile generation module 910 generates a profile for the user and device based upon the selected channel and the particular capabilities of the device. For example, the profile generation module 910 can generate a user profile based on the information included in a user key including selected portions of a manifest, claims, and user authentication information, as described above in conjunction with FIG. 4. Additionally, device capabilities can be sent alongside the user-specific information to ensure that the virtual environment that is generated is capable of operation at the device. For example, information about a particular memory or computing capacity could be sent to the remote system, to be used in generating the virtual user environment.

A profile transmission module 912 transmits the profile generated at the profile generation module 910 to a remote system, such as a server configured to return a virtual user environment. In certain embodiments, the server corresponds to an environment server (e.g. environment server 100 or 204 of FIGS. 1-2, respectively).

An environment receipt module 914 receives a virtual user environment for operation at the computing device, such that the virtual user environment is customized to be user-specific and device-specific based on the information provided in the profile. In certain embodiments, portions of the virtual user environment may be cached at the local device due to previous local operation; in such embodiments, a block-wise data transmission operation can be used to receive blocks of the virtual user environment (e.g., virtual image) that provide the portions of the environment that differ between operational instances. For example, if a first user and a second user use similar environments, only blocks containing differing, user-specific information and settings-based information might be received at the local device, as those are the portions of the image that might change between the environments.

An operation module 916 allows operation of the virtual user profile at the local computing system, using the various components described above in FIG. 6. The operation module 916 coordinates execution of an operating system and other software formed from the blocks of data received from the environment server.

The operation module 916 can, in certain embodiments, provide a user environment that is linked to external user agents, such as networked computing or data devices (e.g., cameras, sensors, etc.). A user can configure the user environment using operation module 916 to collect information while the user is not using the particular virtual place, but so that data is updated the next time the user loads that virtual place (as described above in conjunction with FIG. 2).

Although aspects of the operation module 916 can execute at a user device, additional operations could concurrently execute at least in part at an environment server or within a cloud computing arrangement. For example, a virtual agent or other type of web service could be enabled in conjunction with the with the user environment to manage alerts, changes, and scheduled events. Additionally, updates to the user environment (described in connection with FIG. 10, below) are coordinated between a user device and an environment server or other analogous cloud computing arrangement.

An end operation 918 corresponds to completed delivery of the virtual user environment.

Although described in a particular order, the above modules could be performed in different order, based upon the particular implementation of the methods and systems described herein. For example, in certain embodiments, the user authentication module 904 could request authentication from a user after operation of the channel reception module, and could operate in a manner dependent upon the particular profile or channel selected. For example, a first “virtual place” or channel could require a first level of authentication, while a second selected “virtual place” or channel could require a second level of authentication that is different from the first level of authentication, based on selection of that channel. In one example of such an arrangement, a home or entertainment channel could require ID and password authentication, while an investment or work channel or “virtual place” might require additional authentication (e.g., a second authentication step, or a higher level of security, such as biometric authentication.) Additionally (or alternatively), use of a lower-level authentication arrangement could provide a lower level of access within each of the user environments, and a higher level authentication arrangement could be used to provide a higher level of access, and can define the particular claims made that will provide access for that user (as indicated above in conjunction with FIG. 4).

FIG. 10 is a flowchart of methods and systems 1000 for supplying a user and device specific virtualized environment, according to a possible embodiment of the present disclosure. The methods and systems 1000 can be executed at a remote system, such as an environment server as described above in conjunction with FIGS. 1-2. The methods and systems 1000 can be instantiated at a start operation 1002, which corresponds to initial operation of such an environment server and communicative connection to a user device for delivery of user-specific and device-specific virtual environments.

A profile data receipt module 1004 receives profile information from a user device. The profile information can be, in certain embodiments, a set of information about user and device preferences as generated at a user device (e.g., in the profile generation module 910 of FIG. 9, above). A determination module 1006 determines one or more particular software blocks required to form a virtual user environment according to the received profile information. A selection module 1008 retrieves the particular software blocks and forms a virtual user environment for delivery to the requesting device. A delivery module 1010 returns at least a portion of that formed virtual user environment to the requesting device.

An end operation 1010 corresponds to completed delivery of a virtual user environment that is customized for both the user and the device at which the user environment will be utilized.

In certain embodiments, modules 1006-1010 can form and/or deliver only a portion of a virtual user environment. In such instances, those blocks forming the portion of the virtual user environment will be selected and sent to the requesting device (e.g., one or more blocks or portions of blocks as illustrated in FIG. 6). In such embodiments, information about existing software blocks could be received at the environment server alongside the profile information during operation of the profile data receipt module 1004, so that the environment server gains knowledge of which portions of the environment already exist at the user device.

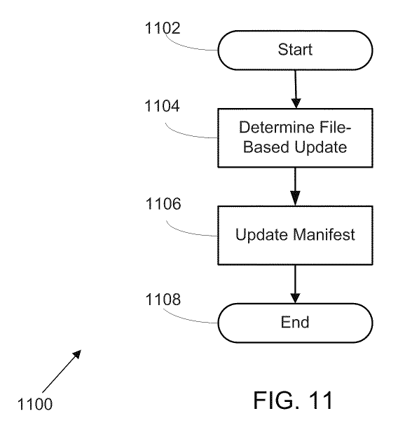

FIG. 11 is a flowchart of systems and methods 1100 for updating user specific aspects of a virtualized environment, according to a possible embodiment of the present disclosure. The systems and methods 1100 describe operation of a client system upon detection of a user change that would cause changes to the virtual user environment the next time the user wishes to use the same virtual user environment (from either the same or a different computing device). A start operation 1102 triggers the methods and systems upon detection of a change that would require such an update.

An update determination module 1104 determines the specific update required based on the change made by the user. A variety of different types of updates can occur. In certain embodiments, the update determination module 1104 determines that an update to the user's manifest is required, due to user changes such as: installation or deletion of an application program; changes to the visual appearance of an environment; addition or deletion of bookmarks; or changes to network or other hardware connectivity settings (e.g. preferred networks, storage systems, and data sources). Other changes could occur as well that would dictate that updates are required.

The update determination module 1104 additionally updates the particular physical memory blocks that make up the image. Changes could be transmitted, for example on a bit-wise basis, to an environment server to store for future use in creating that user's environment on a different computing device. Alternatively, as a user environment is changed, different physical data blocks or portions thereof could also be transmitted from an environment server on a bit-wise basis (for bandwidth utilization efficiency) to update the user environment as changes are made to the manifest (as described below). The update determination module 1104 could be executed at either the user device or at an environment server (or other type of cloud-based computing service) to make changes to the virtual user environment, or to trigger or receive data from external systems. Examples of such updates and data communication can include collection of news, creation/distribution of periodic reports, and receipt of alerts from external devices or systems, as described above.

A manifest update module 1106 updates a user manifest upon receipt of a user change to one of the user profile descriptions, and also translates change made to a virtual user environment to a change to the user's manifest, such as by amending the text or metadata file that defines the user preferences (and optionally the device preferences) that are used in creating the user profile.

For example, a line of text or metadata could be added to the file to represent inclusion of a new application program or user setting, or a line could be removed to signify deletion. Alternatively, the manifest could represent a change log, and additions, deletions, and other changes could each be represented by adding descriptive information to the manifest.

Operation of the update determination module 1104 and manifest update module 1106 can occur concurrently, with updates to a manifest being made in response to changes in a user environment, and vice versa, with changes to the manifest causing changes to the user environment. Such changes could take place during interaction with a virtual user environment by the user, or upon the next time that user attempts to load the same profile and environment. Additionally, changes to a block may or may not require a corresponding change to a manifest, and vice versa. For example, a change to an operating system to add security features or some other improvements may not require a change to a manifest, but would result in at least a bit-wise change to at least a part of the virtual user environment (one or more blocks of that environment).

An end operation 1108 corresponds to completed amendment of the manifest, such that subsequent loading of the virtual user environment according to the user's profile (defined in the manifest) reflects such changes made in the manifest.

Referring now to FIGS. 1-11 generally, virtual user environment delivery systems and methods of use are described that allow a user to view and interact with a common user environment based on one or more profiles included in a manifest. The user environment is provided in a manner that the user experience is customized for that user, but standardized across a variety of types of devices having different capabilities. As the device's capabilities differ (i.e., as the user switches between devices), different, modified versions of the virtual user environment can be provided, with the overall user experience maintained.

The above specification, examples and data provide a complete description of the manufacture and use of the composition of the invention. Since many embodiments of the invention can be made without departing from the spirit and scope of the invention, the invention resides in the claims hereinafter appended.

1. A user computing system configured to host a virtual user environment, the user computing system comprising:
a local memory configured to store a plurality of data blocks;
a programmable circuit operatively connected to the local memory, the programmable circuit configured to execute program instructions which, when executed, cause the user computing system to:
manage profile definition data including a manifest of software associated with a user; and
host a virtual user environment on the device, the virtual user environment including executable instructions specific to the user computing system and constructed from data blocks stored in the local memory, the virtual user environment including a plurality of application programs and settings defined in the manifest.

2. The user computing system of claim 1, wherein the user computing system is a local computing system.

3. The user computing system of claim 1, wherein the programmable circuit is further configured to execute program instructions which, when executed, cause the user computing system to:
provide the manifest to an environment server, vreceive a response from the environment server including one or more data blocks useable to construct the virtual user environment.

4. The user computing system of claim 1, wherein the profile definition data further include a user identifier and one or more rights-based claims.

5. The user computing system of claim 1, further comprising a display device operatively connected to the programmable circuit, the display device configured to display graphical elements of the virtual user environment.

6. The user computing system of claim 1, wherein the executable instructions specific to the user computing system are unexecutable on separate and disparate computing systems.

7. The user computing system of claim 1, wherein the programmable circuit is further configured to execute program instructions which, when executed, cause the user computing system to:
receive bit-wise data providing a differential update to one or more of the data blocks stored in the local memory; and
apply the bit-wise data to the one or more data blocks to update functionality of the virtual user environment.

8. The user computing system of claim 1, wherein the programmable circuit is further configured to execute program instructions which, when executed, cause the user computing system to:
detect a change to the virtual user environment; and
edit the manifest to reflect the change.

9. A virtual user environment management system comprising:
a first user computing device having a first set of computing capabilities;
a second user computing device having a second set of computing capabilities, the second user computing device disparate from the first user computing device and the second set of computing capabilities incompatible with the first set of computing capabilities;
a virtual user environment at least partially defined by a user manifest associated with a user, the virtual user environment providing a common user experience at either the first computing device or the second computing device, the virtual user environment formable from differing pluralities of data blocks, the virtual user environment constructed from a first plurality of data blocks for operation on the first user computing device and constructed from a second plurality of data blocks for operation on the second user computing device.

10. The virtual user environment management system of claim 9, wherein the first plurality of data blocks and the second plurality of data blocks differ to allow operation of the virtual user environment on the first user computing device and the second user computing device.

11. The virtual user environment management system of claim 9, wherein the differing pluralities of data blocks includes a set of common data blocks.

12. The virtual user environment management system of claim 9, wherein the set of common data blocks includes application data and personal information associated with the user and defined in the manifest.

13. The virtual user environment management system of claim 9, wherein the common user experience includes common appearance, preferences, and applications defined in the manifest.

14. The virtual user environment management system of claim 9, wherein the first user computing device executes a type-1 hypervisor software application to host the virtual user environment.

15. The virtual user environment management system of claim 14, wherein the second user computing device executes a type-2 hypervisor software application to host the virtual user environment.

16. The virtual user environment management system of claim 14, wherein the second user computing device is a type-0 appliance useable to host the virtual user environment.

17. The virtual user environment management system of claim 9, wherein each of the first and second user computing devices are configured to receive bit-wise differential updates to the plurality of blocks forming the virtual user environment.

18. The virtual user environment management system of claim 9, further comprising a block cache included in the manifest, the block cache including one or more data blocks stored on one or more of the first and second user computing devices.

19. The virtual user environment management system of claim 18, wherein the block cache is encrypted.

20. The virtual user environment management system of claim 18, wherein the block cache includes driver files related to hardware included in one or both of the first and second user computing devices.

21. A user computing system configured to host a virtual user environment, the user computing system comprising:
a local memory configured to store a plurality of data blocks;
a programmable circuit operatively connected to the local memory, the programmable circuit configured to execute program instructions which, when executed, cause the user computing system to:
manage profile definition data including a manifest of software associated with a user;
provide the manifest to an environment server;
receive a response from the environment server including one or more data blocks useable to construct the virtual user environment on the device, the virtual user environment including executable instructions specific to the user computing system and constructed from data blocks stored in the local memory, the virtual user environment including a plurality of application programs and settings defined in the manifest;
host the virtual user environment on the device;
detect a change to the virtual user environment; and
edit the manifest to reflect the change.
